(19) United States
(12) Patent Application Publication
(10) Pub. No.: US 2024/0362474 A1
(43) Pub. Date: Oct. 31, 2024

(54) Behavior Estimation for Vehicle Management using Machine Learning Models

(71) Applicant: The Boeing Company, Arlington, VA (US)

(72) Inventors: Fan Hin Hung, Los Angeles, CA (US); Joshua Gould Fadaie, St. Louis, MO (US); Deepak Khosla, Camarillo, CA (US); Sean Soleyman, Calabasas, CA (US); Shane Matthew Roach, Phoenix, AZ (US)

(21) Appl. No.: 18/308,264

(22) Filed: Apr. 27, 2023

(51) Int. Cl. G06N 3/08

(52) U.S. Cl. CPC G06N 3/08

(57) ABSTRACT

A vehicle behavior system comprises a computer system, an observation processor, and neural networks. The observation processor and the neural networks are located in the computer system. The observation processor is configured to receive observations for a vehicle system. The observations are for a current time. The observation processor is configured to extract features from the observations. The neural networks are configured to receive the features extracted from the observations and estimate a behavior for the vehicle system for time steps in response to receiving features extracted from the observations processed by the observation processor. Each of the neural networks is trained to estimate the behavior for the vehicle system for a different time step in the time steps.

### BACKGROUND INFORMATION

### 1. Field

The present disclosure relates generally to an improved computer system and in particular, to behavior estimation of vehicles using machine learning models.

### 2. Background

With aircraft simulations, groups of aircraft can be modeled using multi-agent based simulations. Each agent represents an aircraft in the environment. With this type of simulation, each agent has its own set of rules and behaviors for controlling and aircraft. The behaviors of the aircraft and their interactions with each other can be modeled in the simulation.

Each aircraft has sensors that enable the agent to observe the state of the aircraft managed by the agent as well as the environment around the aircraft. The state information can include the location, orientation, and velocity of an aircraft. Further, the state information provided by the sensors can also include the states of other aircraft, weather, and other objects or conditions relating to the environment around the aircraft.

With this information, an agent can perform various operations to influence the behavior of the aircraft. For example, the agent can select a trajectory, a speed, and altitude, or other action based on the evaluation of the state of other aircraft in the environment around aircraft controlled by the agent.

### SUMMARY

An embodiment of the present disclosure provides an aircraft behavior system that comprises a computer system, an observation processor, and neural networks. The observation processor and the neural networks are located in the computer system. The observation processor is configured to receive observations for an aircraft system. The observations are for a current time. The observation processor is configured to extract features from the observations. The neural networks are configured to receive the features extracted from the observations and estimate a behavior for the aircraft system for time steps in response to receiving features extracted from the observations processed by the observation processor. Each of the neural networks is trained to estimate the behavior for the aircraft system for a different time step in the time steps.

Another embodiment of the present disclosure provides a vehicle behavior system comprising a computer system, an observation processor in the computer system, and neural network layer systems in the computer system. The observation processor is configured to receive observations for a vehicle system. The observations are for a current time. The observation processor is configured to extract features from the observations. The neural network layer systems are configured to receive the features from the observation processor. The neural network layer systems are configured to estimate a behavior for the vehicle system for time steps in response to receiving the features extracted from the observations processed by the observation processor, wherein each of the neural network layer systems is trained to estimate the behavior for the vehicle system for a different time step in in the time steps.

Another embodiment of the present disclosure provides a method for determining a behavior for an aircraft system. A computer system receives observations for an aircraft system. The observations are for a current time. The computer system extracts features from the observations. The computer system estimates the behavior for the aircraft system for time steps using neural networks and the features extracted from the observations. Each of the neural networks is trained to estimate the behavior for the aircraft system for a different time step in the time steps.

Yet another embodiment of the present disclosure provides a method for determining a behavior for a vehicle system. A method for determining a behavior for a vehicle system. The computer system receives observations for a vehicle system. The observations are for a current time. The computer system extracts features from the observations. The computer system estimates the behavior for the vehicle system for time steps in response using neural network layer systems and the features extracted from the observations. Each of the neural network layer systems is trained to estimate the behavior for the vehicle system for a different time step in the time steps.

Still another embodiment of the present disclosure provides a computer program product for estimating behavior. The computer program product comprises a computer readable storage medium having program instructions embodied therewith. The program instructions are executable by a computer system to cause the computer system to receive observations for a vehicle system, wherein the observations are for a current time; extract features from the observations; and estimate the behavior for the vehicle system for time steps in response using neural network layer systems and the features extracted from the observations, wherein each of the neural network layer systems is trained to estimate the behavior for the vehicle system for a different time step in the time steps.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is an illustration of a block diagram of a vehicle environment in accordance with an illustrative embodiment;

FIG. 3 is an illustration of neural network layer systems in accordance with an illustrative embodiment;

FIG. 4 is an illustration of an agent in accordance with an illustrative embodiment;

FIG. 5 is an illustration of observations in accordance with an illustrative embodiment;

FIG. 6 is an illustration of a flowchart of a process for determining a behavior for a vehicle system in accordance with an illustrative embodiment;

FIG. 7 is an illustration of a flowchart of a process for controlling a vehicle system in accordance with an illustrative embodiment;

FIG. 8 is an illustration of a flowchart of a process for determining a behavior for an aircraft system in accordance with an illustrative embodiment; and

FIG. 9 is an illustration of a block diagram of a data processing system in accordance with an illustrative embodiment.

### DETAILED DESCRIPTION

The illustrative embodiments recognize and take into account one or more different considerations. An agent can be implemented using a machine learning model or a rule-based system. The processing of data about the environment around the aircraft with a desired speed for real time actions can be more difficult than desired. Aircraft simulations can be complex and the behavior of individual agents for the aircraft can depend on many factors such as the behavior of other agents, weather conditions, other objects, and other factors.

As the number of aircraft increases, a large number of agents can be present in which each agent is expected to behave in a realistic manner. This type of simulation can use large amounts of computing resources such as processor resources and memory. Further, the accuracy and realism of the simulations can be difficult to achieve as the number of aircraft increases within the simulation.

An agent can be implemented using a machine learning model, a genetic algorithm, masking, rules, or other types of components. These components have been individually used but not in combination. Further, current techniques work on a one versus one (1 v 1) basis and cannot handle a team of aircraft such as two versus two (2 v 2) or two versus one (2 v 1).

Thus, illustrative embodiments provide a method, apparatus, system, and computer program product for estimating behavior of an aircraft system. The behavior of one or more aircraft may be estimated. In one illustrative example, an aircraft behavior system comprises a computer system, an observation processor, and neural networks. The observation processor and the neural networks were located in the computer system. The observation processor is configured to receive observations for an aircraft system. The observations are for a current time. The observation processor is configured to extract features from the observations. The neural networks are configured to receive the features extracted from the observations and estimate a behavior for the aircraft system for time steps in response to receiving features extracted from the observations processed by the observation processor. Each of the neural networks is trained to estimate the behavior for the aircraft system for a different time step.

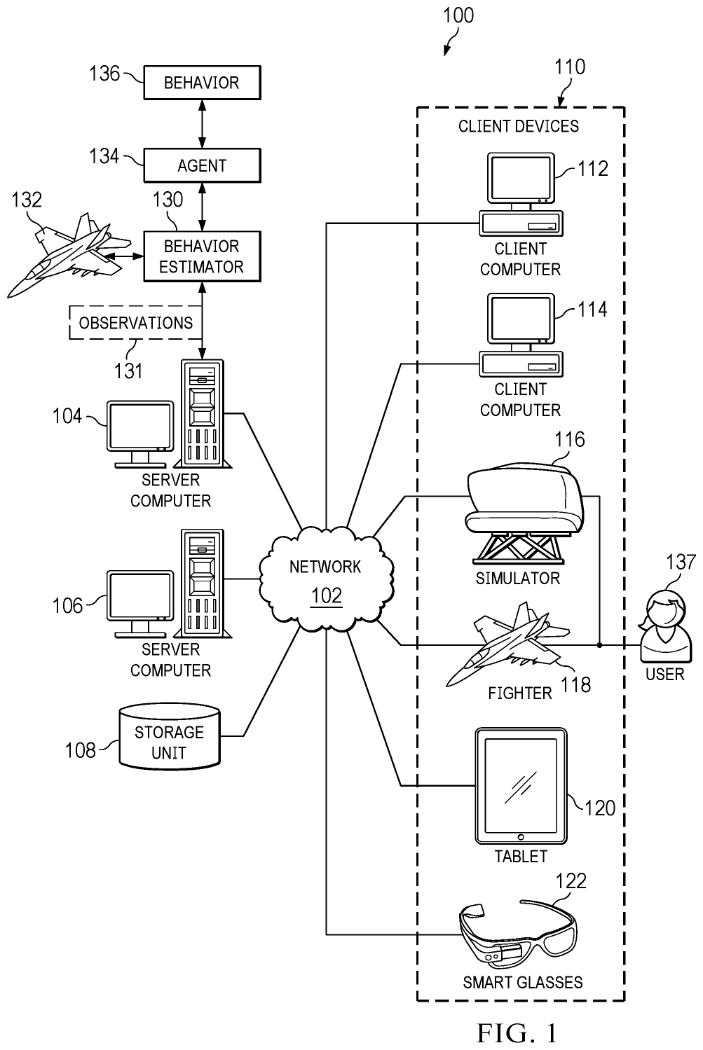

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. Client devices 110 can be, for example, computers, workstations, network computers, vehicles, machinery, appliances, or other devices that can process data. As depicted, client devices 110 include client computer 112, client computer 114, simulator 116, fighter 118, tablet computer 120, and smart glasses 122. In the depicted example, server computer 104 provides information, such as boot files, operating system images, and applications to client devices 110.

In the depicted example, server computer 104 provides information, such as boot files, operating system images, and applications to client devices 110. Further, in this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program instructions located in network data processing system 100 can be stored on a computer-recordable storage medium and downloaded to a data processing system or other device for use. For example, program instructions can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols or other networking protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

In this illustrative example, behavior estimator 130 can estimate behavior 136 of aircraft system 132 using agent 134. In this example, aircraft system 132 can be one or more aircraft. For example, aircraft system 132 can be a single aircraft. In another example, aircraft system 132 can be a team of two or more aircraft.

In this example, behavior estimator 130 receives observations 131. Observations 131 are observations for aircraft system 132. These observations can include information about the state of aircraft system 132 and the environment around aircraft system 132. Information about the state of aircraft system 132 can include fuel level, temperature, fuel consumption, location, attitude, and other information about the state of aircraft system 132. Information about the environment around aircraft system 132 can include temperature, pressure, location of other aircraft mission information, and other information.

In this example, behavior 136 can be estimated by agent 134 using an observation processor and neural networks in agent 134. The observation processor can extract features. This extraction can involve placing information from observations 131 to a format used by the neural networks. Neural networks are configured to estimate the behavior 136 of aircraft system 132 over time periods. These time periods can include a current time and some number of future times.

With the estimation of behavior 136, behavior estimator 130 can send behavior 136 over network 102 to client devices 110. These client devices can display or analyze behavior 136.

For example, behavior 136 can be sent over network 102 to simulator 116 in which simulator 116 displays behavior 136 performed by aircraft system 132 to user 137 operating simulator 116 as part of a training exercise. With the display of behavior 136 for aircraft system 132, user 137 can perform actions in the training exercise in response to visualizing and receiving information for behavior 136 for aircraft system 132.

In another example, user 137 can operate fighter 118. With this example, behavior 136 can be sent to fighter 118 over network 102 for display to user 137. In this example, fighter 118 can display behavior 136 on a heads-up display, a display system, or instrumentation panel in fighter 118. With the display of behavior 136 for aircraft system 132, user 137 can operate fighter 118 to perform different actions as part of a training exercise using fighter 118.

In yet other illustrative examples, behavior 136 can be sent to other client devices in client devices 110. Behavior 136 can be displayed on the client devices to other users who may participate in the training exercise or may analyze behavior 136 of aircraft system 132. For example, behavior 136 can also be sent to client computer 112, client computer 114, tablet computer 120, or smart glasses 122. These different client devices can display behavior 136. In other illustrative examples, one or more of client devices 110 can analyze behavior 136 to perform other actions. For example, these client devices can also include agents that predict behavior for aircraft, ships, or other types of vehicles using behavior 136. In these examples, this behavior can be treated as observations for vehicles for which the client devices estimate behaviors.

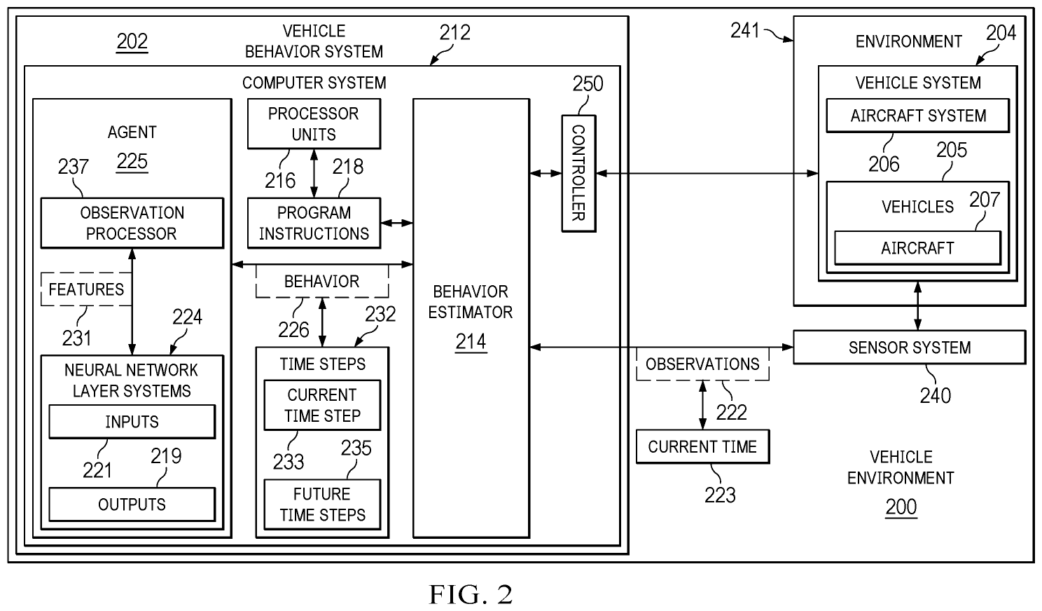

With reference now to FIG. 2, an illustration of a block diagram of a vehicle environment is depicted in accordance with an illustrative embodiment. In this illustrative example, vehicle environment 200 includes components that can be implemented in hardware such as the hardware shown in network data processing system 100 in FIG. 1.

In this illustrative example, vehicle behavior system 202 can estimate behavior 226 for vehicle system 204. Vehicle system 204 is a set of vehicles 205. As used herein, “a set” of when used with reference to items means one or more items. For example, a set of vehicles 205 is one or more of vehicles 205.

Vehicle system 204 can be selected from a group comprising a single vehicle and a plurality of vehicles. In one illustrative example, vehicle system 204 can take the form of aircraft system 206. With this example, the set of vehicles 205 is a set of aircraft 207.

The set of vehicles 205 can take a number of different forms. For example, the set of vehicles 205 in vehicle system 204 can be selected from at least one of a mobile platform, an aircraft, a fighter, a commercial airplane, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a submarine, a spacecraft, an automobile, or other vehicle.

As depicted, vehicle behavior system 202 comprises computer system 212 and behavior estimator 214. Behavior estimator 214 is located in computer system 212.

Behavior estimator 214 can be implemented in software, hardware, firmware, or a combination thereof. When software is used, the operations performed by behavior estimator 214 can be implemented in program instructions configured to run on hardware, such as a processor unit. When firmware is used, the operations performed by behavior estimator 214 can be implemented in program instructions and data and stored in persistent memory to run on a processor unit. When hardware is employed, the hardware may include circuits that operate to perform the operations in behavior estimator 214.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 212 is a physical hardware system and includes one or more data processing systems. When more than one data processing system is present in computer system 212, those data processing systems are in communication with each other using a communications medium. The communications medium may be a network. The data processing systems may be selected from at least one of a computer, a server computer, a tablet, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program code that operate a computer. When the number of processor units 216 executes program instructions 218 for a process, the number of processor units 216 can be one or more processor units that are in the same computer or in different computers. In other words, the process can be distributed between processor units 216 on the same or different computers in a computer system 212.

Further, the number of processor units 216 can be of the same type or different type of processor units. For example, a number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, behavior estimator 214 can estimate behavior 226 for vehicle system 204 using agent 225. Agent 225 can estimate behavior 226 using observations 222 for vehicle system 204 using observations 222.

In this example, observations 222 can be made using sensor system 240. Sensor system 240 comprises sensors that generate data that form observations 222 for vehicle system 204. The sensors in sensor system 240 can be located in at least one of vehicle system 204 or in environment 241 around vehicle system 204. The sensors can be actual physical sensors or sensors in a simulation.

In this illustrative example, sensors in sensor system 240 are sources of data that can be sent as a data stream in observations 222 to behavior estimator 214. These observations are transmitted behavior estimator 214. Behavior estimator 214 sends observations 222 to agent 225 for processing to obtain behavior 226.

In this illustrative example, agent 225 comprises a number of different components. As depicted, agent 225 includes observation processor 237 and neural network layer systems 224. Observation processor 237 can be selected from at least one of a machine learning model, a neural network, a neural network layer, or a multi-layer perceptron, a rule-based system, or some other suitable type of system. Neural network layer systems 224 can be implemented in at least one of a proximal optimization neural network, recurrent neural network, a reinforcement learning neural network, a multi-layer perceptron, or some other suitable type of neural network.

As depicted, observation processor 237 is configured to receive observations 222 for vehicle system 204. In this example, observations 222 are for current time 223. Observation processor 237 is configured to extract features 231 from observations 222. Features 231 can take a number of different forms. Features 231 are in a form or format that neural network layer systems 224 expects as inputs. Features 231 can also include processing of observations 222 to information such as velocity, acceleration, or other information that can be calculated or determined using information in observations 222.

In this example, each of neural network layer systems 224 has inputs 221 connected to observation processor 237. Each input in inputs 221 is configured to receive features 231 extracted by observation processor 237. In this example, neural network layer systems 224 are configured to receive features 231 from observation processor 237. Neural network layer systems 224 are configured to estimate behavior 226 for vehicle system 204 for time steps 232 in response to receiving features 231 extracted from observations 222 processed by observation processor 237. Time steps 232 can be, for example, current time step 233 and a number of future time steps 235.

In this example, the estimate of behavior 226 can include determining one or more current actions for vehicle system 204 based on observations 222 for the current time. Further, this estimate of behavior can also include a prediction of one or more actions for vehicle system 204 at one or more future times.

Behavior 226 can take a number of different forms. For example, behavior 226 can be selected from at least one of a maneuver behavior, a non-maneuver behavior, a route vectoring, a route formation, an ingress vectoring, an ingress formation, an intercept, a missile intercept, a pure pursuit, a vectoring, a crank, a grinder, a pump, an egress, a first vector relative to a primary adversary aircraft, a second vector relative to a primary adversary aircraft centroid, or a third vector relative to a primary adversary missile centroid, or other behaviors.

In this depicted example, neural network layer systems 224 have outputs 219. Outputs 219 output behavior 226. Each output in outputs 219 outputs behavior 226 for a particular time step in time steps 232.

In this example, each of neural network layer systems 224 is trained to estimate behavior 226 for vehicle system 204 for a time step in in time steps 232. In other words, each neural network layer systems 224 can estimate behavior 226 for a different time step. For example, one neural network layer system can estimate behavior 226 for a current time in time steps 232. Another neural network layer system can estimate behavior 226 for a time step of t plus one. The period of time for a time step can take a number of different values. For example, a time step can be 0.5 seconds, 1.0 seconds, 3.0 seconds, 40 seconds, 1 minute, or some other period of time.

One illustrative example, controller 250 is in communication with vehicle system 204. Controller 250 can control vehicle system 204 using behavior 226 estimated by neural network layer systems 224. In other words, controller 250 can control the actions of vehicle system 204 using behavior 226. In this illustrative example, controller 250 can translate behavior 226 into commands or instructions that are recognized and used by vehicle system 204.

As a result, agent 225, using observation processor 237 and neural network layer systems 224, can provide automated analysis for determining behavior 226 of vehicle system 204. In this depicted example, agent 225 can be trained using reinforcement learning.

In one example, agent 225 and other agents can be used in training scenarios such as aircraft training. This aircraft training can include commercial aircraft, military aircraft, and other types of aircraft. Scenarios can be created with opposing teams of aircraft in which one team can be controlled by agent 225 and another team can be controlled by human operators who are training on a particular aircraft. This training can take place in simulators, actual aircraft, or using other types of computing devices that can present behaviors of the aircraft to the human operators in the training session. Simulations can also be run in which both sides are controlled by agents.

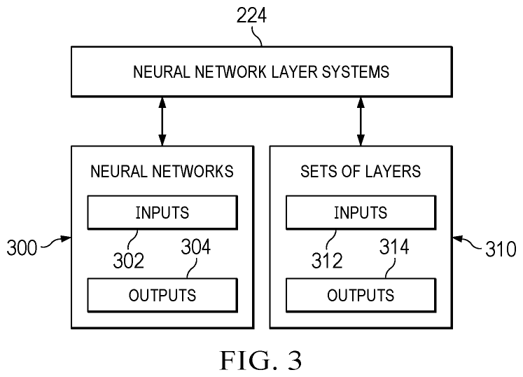

Next in FIG. 3, an illustration of neural network layer systems is depicted in accordance with an illustrative embodiment. In the illustrative examples, the same reference numeral may be used in more than one figure. This reuse of a reference numeral in different figures represents the same element in the different figures.

In this illustrative example, an example of implementations for neural network layer systems 224 is depicted. As depicted, neural network layer systems 224 can take a number of different forms. In one illustrative example, neural network layer systems 224 take the form of neural networks 300. In other words, each neural network layer system in neural network layer systems 224 can be implemented as a neural network.

With this implementation, neural networks 300 has inputs 302 and outputs 304. Each neural network in neural networks 300 has an input in inputs 302 that receives features from observation processor 237 in FIG. 2. In other words, all of neural networks 300 received the same features. Neural networks 300 also has outputs 304. Each neural network in neural networks 300 outputs one or more actions that contribute to behavior 226.

In this example, the actions output from each of outputs 304 from neural networks 300 are for a different time step in time steps 232 and FIG. 2. In other words, each neural network has been trained to estimate behavior 226 for a particular time step. As a result, neural networks 300 can estimate behavior 226 for multiple time steps 232.

In another illustrative example, neural network layer systems 224 can take the form of sets of layers 310. In this example, sets of layers 310 can be located in a neural network.

With this example, sets of layers 310 have inputs 312 and outputs 314. Each set of layers in sets of layers 310 has an input in inputs 312 that receives features from observation processor 237 in FIG. 2. In other words, all sets of layers 310 receive the same features.

Sets of layers 310 also have outputs 314. Each neural network in neural networks 300 outputs one or more actions from outputs 314 that contribute to behavior 226.

In this illustrative example, the estimation of behavior 226 by neural networks 300 or sets of layers 310 can be for one vehicle or multiple vehicles. With multiple vehicles, these vehicles can be on the same team. These vehicles can be of the same or different types of vehicles. For example, some of the vehicles can be aircraft while other vehicles can be ground vehicles or ships. In yet another illustrative example, some vehicles can be autonomous vehicles or piloted vehicles, and some vehicles can be remotely piloted vehicles in the behavior estimated for the vehicles.

In one illustrative example, one or more technical solutions are present that overcome a problem with predicting behavior for multiple aircraft with the desired level of realism for a simulation. As a result, one or more solutions may provide an ability to predict behavior for an aircraft system over multiple time steps. These time steps include a current time and some number of future times. The illustrative examples provide a practical application for displaying estimated behavior for an aircraft system that can contain one or more aircraft. This display provides a desired level realism for training exercises.

Computer system 212 can be configured to perform at least one of the steps, operations, or actions described in the different illustrative examples using software, hardware, firmware, or a combination thereof. As a result, computer system 212 operates as a special purpose computer system in which behavior estimator 214 in computer system 212 enables determining behavior using an agent. In these examples, the agent is comprised of neural network layer systems that all receive features from an observation processor. Each of the neural network layer systems can determine the behavior of a vehicle system for a time step in a series of time steps. As result, the agent can determine behavior for vehicle over multiple time steps. Behavior estimator 214 using agent 225 transforms computer system 212 into a special purpose computer system as compared to currently available general computer systems that do not have behavior estimator 214.

In the illustrative example, the use of behavior estimator 214 in computer system 212 integrates processes into a practical application for increasing the performance of computer system 212 in determining behavior of vehicles. In other words, behavior estimator 214 in computer system 212 is directed to a practical application of processes integrated into behavior estimator 214 in computer system 212 that determines the behavior using an agent architecture that enables determining behavior for vehicle systems that can have one or more vehicles.

The illustration of vehicle environment 200 in the different components in this environment in FIGS. 2-3 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, one or more vehicle systems can be present in addition to vehicle system 204. Behavior from these vehicle systems can be estimated using one or more agents in addition to agent 225.

As another illustrative example, agent 225 in computer system 212 are shown as separate blocks from vehicle system 204. In some illustrative examples, a portion or all of computer system 212 can be located in vehicle system 204. With this example, agent 225 can also run in vehicle system 204.

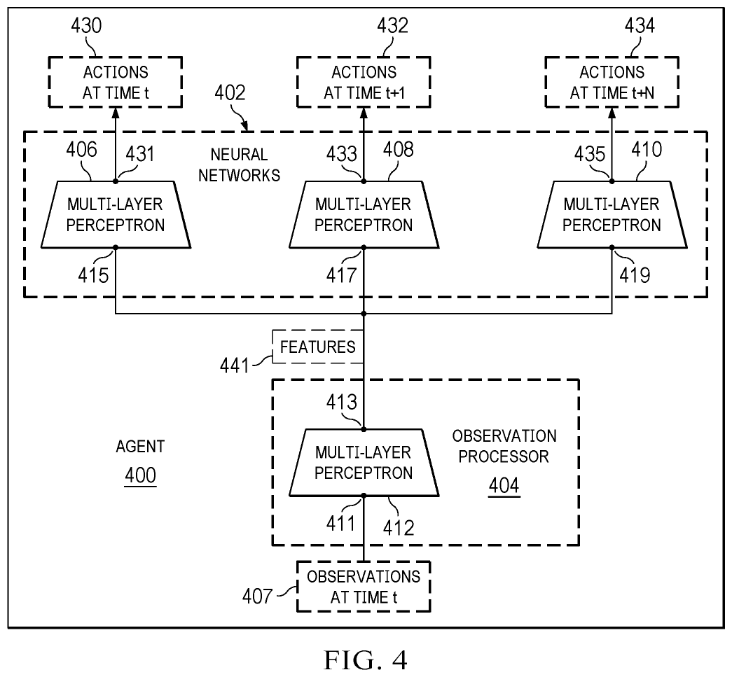

Turning next to FIG. 4, an illustration of an agent is depicted in accordance with an illustrative embodiment. In this illustrative example, agent 400 is an example of an implementation for agent 225 in FIG. 2. In this illustrative example, agent 400 is comprised of neural networks 402 and observation processor 404.

In this example, neural networks 402 uses multi-layer perceptrons. As shown, neural networks 402 is comprised of multi-layer perceptron 406, multi-layer perceptron 408, and multi-layer perceptron 410. As depicted, observation processor 404 is also implemented using a neural network in the form of multi-layer perceptron 412. In other illustrative examples, neural networks 402 can be implemented using other types of neural networks.

For example, neural networks 402 can be implemented using proximal policy optimization neural networks or reinforcement learning neural networks. As another example, observation processor 404 can be implemented using different types of systems as compared to neural networks 402. Further, observation processor 404 can be implemented using a proximal policy optimization neural network, a reinforcement learning neural network, a rule-based system, a knowledge base, or other type of system that is capable of creating features from observations 407.

In these examples, a proximal policy optimization neural network is a neural network trained proximal policy optimization algorithm. A reinforcement learning neural network is a neural network trained using a reinforcement learning algorithm.

Further in these examples, observation processor 404 can be trained at the same time as neural networks 402. In other illustrative examples, observation processor 404 can be trained at a different time from neural networks 402.

As depicted in this example, observation

processor 404 receives observations 407 at input 411. In this example, observations 407 are at time t. In this example, time t is the current time. In other examples, time t could be a past time from historical data. Observation processor 404 processes observations 407 to generate features 441. These features output from observation processor 404 at output 413. Output 413 is connected to input 415 in multi-layer perceptron 406; input 417 in multi-layer perceptron 408; and input 419 in multi-layer perceptron 410. As depicted, features 441 are sent from output 413 into these inputs. As shown, each of these multi-layer perceptrons receives the same features for processing to determine the behavior of the vehicle system over different time steps.

In this illustrative example, multi-layer perceptron 406, multi-layer perceptron 408, and multi-layer perceptron 410 outputs actions for different time steps. As depicted, multi-layer perceptron 406 outputs actions 430 at time t from output 431; multi-layer perceptron 408 outputs actions 432 at time t+1 from output 433, and multi-layer perceptron 410 outputs actions 434 at time t+N from output 435.

In this illustrative example, the neural networks 402 in agent 400 can be trained using reinforcement learning techniques for machine learning models. In one example, observations logged from one or more simulations can be used to create training data. This training data can include input and output datasets for parametrized functions to be trained. Each neural network is trained using this training dataset. The training can be performed using deep learning practices for neural networks. These parametrized functions and training of the neural networks can be performed using using a gradient descent. Gradient descent is an algorithm that can be used to train neural networks 402 to increase the accuracy of behavior predictions. Gradient descent can use small adjustments to weights for the neural networks based on a gradient of a cost function that measures the difference between the estimate of the behavior made by neural networks 402 and the actual behavior in the training data set.

In this example, the deep learning model architecture uses multi-layer perceptrons (MLPs). With this type of neural network, a multi-layer perceptron receives an observation vector from the current time step as input and outputs the next action to estimate the behavior.

In this example, to predict actions for future times, multiple multi-layer perceptrons are trained in which each multi-layer perceptron receives observations 407 at time t as the input. These multi-layer perceptrons output a set of actions for the next consecutive time step. In other words, this approach can train one multi-layer perceptron to map a and observation at time step t to the observation at this time step. The next multi-layer perceptron is trained to map the observation that time t to the action at time t+1.

In this example, observation processor 404 is a neural network in the form of a multi-layer perceptron that has been trained to map observations into features. In illustrative example, the observations can have many dimensions and the observation processor 404 can transform or map these higher-level dimensions into a lower number of dimensions that are features for use by neural networks 402 to predict actions for the behavior of a vehicle system.

The depiction of agent 400 in this figure is provided as an illustration of one manner in which agent 225 in FIG. 2 can be implemented. This figure is not meant to limit the manner in which agents can be implemented in other examples. For example, other numbers of neural networks are present other than the three neural networks shown. In other illustrative examples, 2 neural networks, 7 neural networks, 50 neural networks, or some other number of neural networks can be used depending on the number of time steps desired.

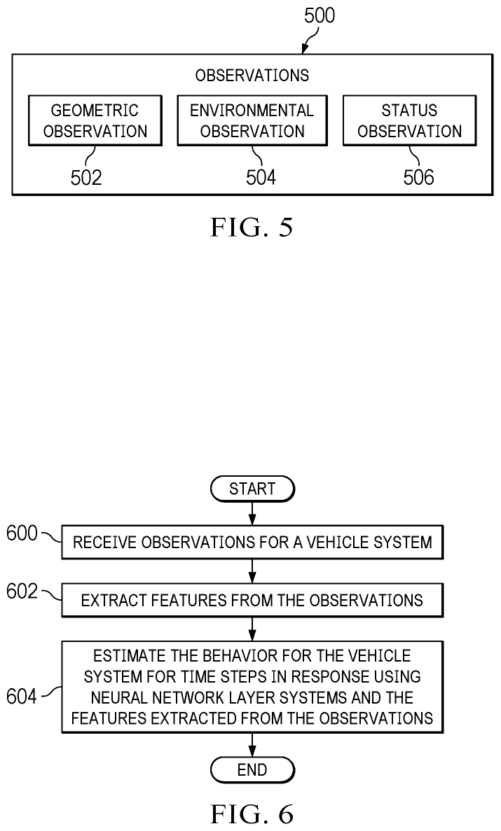

With reference next to FIG. 5, an illustration of observations is depicted in accordance with an illustrative embodiment. As depicted, observations 500 are examples of types of observations that can be found in observations 222 in FIG. 2. As depicted, observations 500 can be selected from at least one of geometric observation 502, environmental observation 504, or a status observation 506, or some other type of observation.

In this illustrative example, geometric observation 502 is information objects in environment around a vehicle system. These observations can include, at least one of a location, an orientation, a speed, a velocity, a track, or other information about objects. This information can also include an altitude difference, a relative bearing, a closing speed, a relative velocity, a slant range, a cross range, a downrange, and other information about vehicles relative to the vehicle system. This information in geometric observation 502 can also include the number of objects, types of objects, whether objects are friendly, objects in the team, objects of the different team, and other information about objects.

Further in this example, environmental observation 504 is information about the environment around the vehicle system. This information can be selected from at least one of a temperature, a pressure, a humidity, weather, or other information about the environment.

In this illustrative example, status observation 506 can be information about vehicle system 204. For example, the information can include, at least one of a fuel level, a cabin pressure, a speed, an acceleration, a velocity, a route, an engine temperature, a flap setting, a power generation level, an amount of ammunition, an adversary identification, or other information about the state of the vehicle system.

Turning next to FIG. 6, an illustration of a flowchart of a process for determining a behavior for a vehicle system is depicted in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in behavior estimator 214 in computer system 212 in FIG. 2.

The process begins by receiving observations for a vehicle system (operation 600). In operation 600, observations are for a current time.

The process extracts features from the observations (operation 602). The process estimates the behavior for the vehicle system for time steps in response using neural network layer systems and the features extracted from the observations (operation 604). The process terminates thereafter.

In operation 604, each of the neural network layer systems is trained to estimate the behavior for the vehicle system for a time step in in the time steps. This time step is a different time step from the other time steps estimated by the other neural network systems.

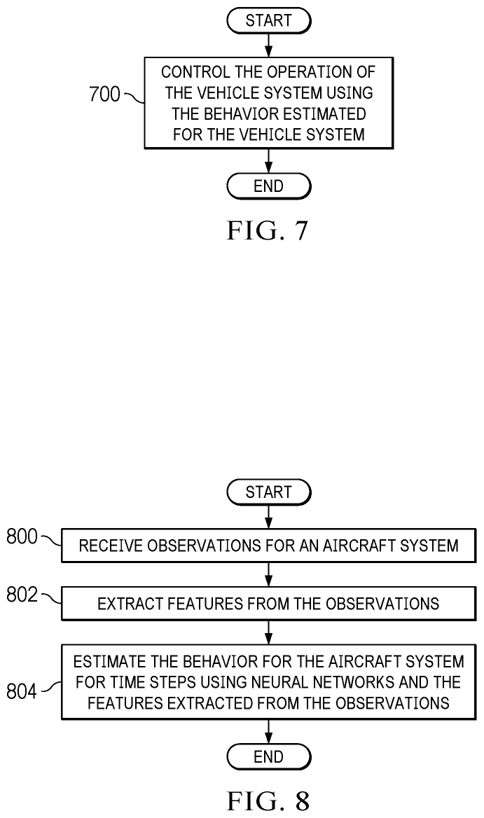

With reference to FIG. 7, an illustration of a flowchart of a process for controlling a vehicle system is depicted in accordance with an illustrative embodiment. The process illustrated in FIG. 7 is an example of an additional operation that can be performed with the operations in FIG. 6.

The process controls the operation of the vehicle system using the behavior estimated for the vehicle system (operation 700). The process terminates thereafter.

Turning to FIG. 8, an illustration of a flowchart of a process for determining a behavior for an aircraft system is depicted in accordance with an illustrative embodiment. The process in FIG. 8 can be implemented in hardware, software, or both. When implemented in software, the process can take the form of program instructions that are run by one of more processor units located in one or more hardware devices in one or more computer systems. For example, the process can be implemented in behavior estimator 214 in computer system 212 in FIG. 2.

The process begins by receiving observations for an aircraft system (operation 800). In this operation, the observations are for a current time. The aircraft system can be one aircraft or can be multiple aircraft.

The process extracts features from the observations (operation 802). The process estimates the behavior for the aircraft system for time steps using neural networks and the features extracted from the observations (operation 804). The process terminates thereafter. In operation 804, each of the neural networks is trained to estimate the behavior for the aircraft system for a different time step in the time steps. In this example, each of the neural networks can estimate the behavior for each aircraft individually or for the aircraft as a team.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

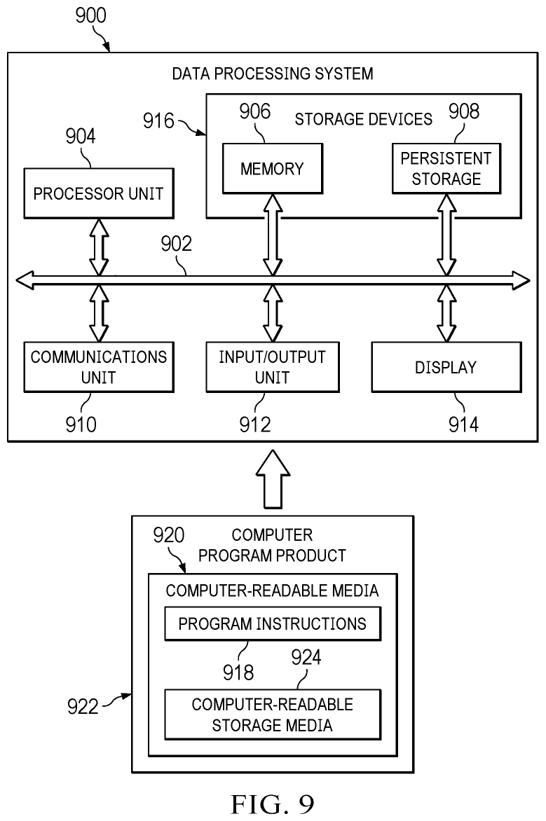

Turning now to FIG. 9, a block diagram of a data processing system is depicted in accordance with an illustrative embodiment. Data processing system 900 can be used to implement server computer 104, server computer 106, client devices 110, in FIG. 1. Data processing system 900 can also be used to implement computer system 212 in FIG. 2. In this illustrative example, data processing system 900 includes communications framework 902, which provides communications between processor unit 904, memory 906, persistent storage 908, communications unit 910, input/output (I/O) unit 912, and display 914. In this example, communications framework 902 takes the form of a bus system.

Processor unit 904 serves to execute instructions for software that can be loaded into memory 906. Processor unit 904 includes one or more processors. For example, processor unit 904 can be selected from at least one of a multicore processor, a central processing unit (CPU), a graphics processing unit (GPU), a physics processing unit (PPU), a digital signal processor (DSP), a network processor, or some other suitable type of processor. Further, processor unit 904 can be implemented using one or more heterogeneous processor systems in which a main processor is present with secondary processors on a single chip. As another illustrative example, processor unit 904 can be a symmetric multi-processor system containing multiple processors of the same type on a single chip.

Memory 906 and persistent storage 908 are examples of storage devices 916. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 916 may also be referred to as computer readable storage devices in these illustrative examples. Memory 906, in these examples, can be, for example, a random-access memory or any other suitable volatile or non-volatile storage device. Persistent storage 908 may take various forms, depending on the particular implementation.

For example, persistent storage 908 may contain one or more components or devices. For example, persistent storage 908 can be a hard drive, a solid-state drive (SSD), a flash memory, a rewritable optical disk, a rewritable magnetic tape, or some combination of the above. The media used by persistent storage 908 also can be removable. For example, a removable hard drive can be used for persistent storage 908.

Communications unit 910, in these illustrative examples, provides for communications with other data processing systems or devices. In these illustrative examples, communications unit 910 is a network interface card.

Input/output unit 912 allows for input and output of data with other devices that can be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs can be located in storage devices 916, which are in communication with processor unit 904 through communications framework 902. The processes of the different embodiments can be performed by processor unit 904 using computer-implemented instructions, which may be located in a memory, such as memory 906.

These instructions are referred to as program instructions, computer usable program instructions, or computer readable program instructions that can be read and executed by a processor in processor unit 904. The program instructions in the different embodiments can be embodied on different physical or computer readable storage media, such as memory 906 or persistent storage 908.

Program instructions 918 are located in a functional form on computer readable media 920 that is selectively removable and can be loaded onto or transferred to data processing system 900 for execution by processor unit 904. Program instructions 918 and computer readable media 920 form computer program product 922 in these illustrative examples. In the illustrative example, computer readable media 920 is computer readable storage media 924.

Computer readable storage media 924 is a physical or tangible storage device used to store program instructions 918 rather than a medium that propagates or transmits program instructions 918. Computer readable storage media 924 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer readable storage media 924, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation, or garbage collection. However, these operations do not render the storage device as transitory because the data is not transitory while the data is stored in the storage device.

Alternatively, program instructions 918 can be transferred to data processing system 900 using a computer readable signal media. The computer readable signal media are signals and can be, for example, a propagated data signal containing program instructions 918. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 920” can be singular or plural. For example, program instructions 918 can be located in computer readable media 920 in the form of a single storage device or system. In another example, program instructions 918 can be located in computer readable media 920 that is distributed in multiple data processing systems. In other words, some instructions in program instructions 918 can be located in one data processing system while other instructions in program instructions 918 can be located in one data processing system. For example, a portion of program instructions 918 can be located in computer readable media 920 in a server computer while another portion of program instructions 918 can be located in computer readable media 920 located in a set of client computers.

The different components illustrated for data processing system 900 are not meant to provide architectural limitations to the manner in which different embodiments can be implemented. In some illustrative examples, one or more of the components may be incorporated in or otherwise form a portion of another component. For example, memory 906, or portions thereof, may be incorporated in processor unit 904 in some illustrative examples. The different illustrative embodiments can be implemented in a data processing system including components in addition to or in place of those illustrated for data processing system 900. Other components shown in FIG. 9 can be varied from the illustrative examples shown. The different embodiments can be implemented using any hardware device or system capable of running program instructions 918.

Thus, the different illustrative examples provide a method, apparatus, system, and computer program product for estimating behavior of vehicle systems. The estimation behavior can be used to control vehicle systems to implement the estimated behavior. A vehicle behavior system comprises a computer system, an observation processor, and neural networks. The observation processor and the neural networks are located in the computer system. The observation processor is configured to receive observations for a vehicle system. The observations are for a current time. The observation processor is configured to extract features from the observations. The neural networks are configured to receive the features extracted from the observations and estimate a behavior for the vehicle system for time steps in response to receiving features extracted from the observations processed by the observation processor. Each of the neural networks is trained to estimate the behavior for the vehicle system for a different time step in the time steps.

With the use of an agent having multiple neural network layer systems and an observation processor, the estimate of behavior for vehicle system can be performed with increased accuracy, especially when multiple vehicles are present in a vehicle system. This type of behavior estimation can be especially useful in aircraft training exercises involving teams of aircraft with multiple aircraft on each team.

An aircraft behavior system can model the behavior of multiple aircraft in different training exercises. These training exercises can include teams that compete against each other. In one illustrative example, one or more agents can be used to estimate the behavior of aircraft on one team while human operators control another team. In this case, the use of agents to control a team can provide increased realism to the training exercise. For example, the behavior estimation performed in the illustrative examples can be performed to train friendly aircraft. This behavior estimation can be performed to predict the behavior of an enemy aircraft. As a result, the behavior systems can help operators of the friendly aircraft plan around actions that are being performed and that may be performed in the future by the enemy aircraft.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated. cm What is claimed is:

1. An aircraft behavior system comprising:
a computer system;
an observation processor in the computer system, wherein the observation processor is configured to:
receive observations for an aircraft system, wherein the observations are for a current time;
extract features from the observations; and
neural networks in the computer system, wherein the neural networks are configured to:
receive the features extracted from the observations; and
estimate a behavior for the aircraft system for time steps in response to receiving the features extracted from the observations processed by the observation processor, wherein each of the neural networks is trained to estimate the behavior for the aircraft system for a different time step in the time steps.

2. The aircraft behavior system of claim 1, wherein each of the neural networks has an input connected to the observation processor in which the input is configured to receive the features and an output that is configured to output the behavior for the different time step.

3. The aircraft behavior system of claim 1 further comprising:
a controller in communication with the aircraft system, wherein the controller controls the aircraft system using the behavior estimated by the neural networks.

4. The aircraft behavior system of claim 1, wherein the aircraft system is selected from a group comprising a single aircraft and a plurality of aircraft.

5. The aircraft behavior system of claim 1, wherein the observation processor and the neural networks are located in an agent for the aircraft system.

6. The aircraft behavior system of claim 1, wherein the observations are selected from at least one of a geometric observation, an environmental observation, or a status observation.

7. The aircraft behavior system of claim 1, wherein the behavior is selected from at least one of a maneuver behavior, a non-maneuver behavior, a route vectoring, a route formation, an ingress vectoring, an ingress formation, an intercept, a missile intercept, a pure pursuit, a vectoring, a crank, a grinder, a pump, an egress, a first vector relative to a primary adversary aircraft, a second vector relative to a primary adversary aircraft centroid, or a third vector relative to a primary adversary missile centroid.

8. The aircraft behavior system of claim 1, wherein the time steps are for the current time and a number of future time steps.

9. The aircraft behavior system of claim 1, wherein the observation processor is selected from at least one of a machine learning model, a neural network, a neural network layer, or a multi-layer perceptron, or a rule-based system.

10. The aircraft behavior system of claim 1, wherein the neural networks are selected from at least one of a proximal policy optimization neural network, recurrent neural network, a reinforcement learning neural network, or a multi-layer perceptron.

11. A vehicle behavior system comprising:
a computer system;
an observation processor in the computer system, wherein the observation processor is configured to:
receive observations for a vehicle system, wherein the observations are for a current time;
extract features from the observations; and
neural network layer systems in the computer system, wherein the neural network layer systems are configured to:
receive the features from the observation processor; and
estimate a behavior for the vehicle system for time steps in response to receiving the features extracted from the observations processed by the observation processor, wherein each of the neural network layer systems is trained to estimate the behavior for the vehicle system for a different time step in the time steps.

12. The vehicle behavior system of claim 11, wherein the neural network layer systems are neural networks.

13. The vehicle behavior system of claim 11, wherein the neural network layer systems are sets of layers in a neural network, wherein each set of layers has an input to receive the features from the observation processor and an output to output the behavior for the different time step.

14. The vehicle behavior system of claim 11, wherein the time steps comprise the current time and a number of future time steps.

15. The vehicle behavior system of claim 11, wherein the observation processor is selected from at least one of a machine learning model, a neural network, a neural network layer, or a multi-layer perceptron, or a rule-based system.

16. The vehicle behavior system of claim 11, wherein the neural network layer systems are selected from at least one of a proximal optimization neural network, recurrent neural network, a reinforcement learning neural network, or a multi-layer perceptron.

17. The vehicle behavior system of claim 11, wherein the vehicle system is selected from a group comprising a single vehicle and a plurality of vehicles.

18. The vehicle behavior system of claim 11, wherein the vehicle system is selected from at least one of a mobile platform, an aircraft, a fighter, a commercial airplane, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a submarine, a spacecraft, or an automobile.

19. A method for determining a behavior for an aircraft system, the method comprising:
receiving, by a computer system, observations for the aircraft system, wherein the observations are for a current time;
extracting, by the computer system, features from the observations; and
estimating, by the computer system, the behavior for the aircraft system for time steps using neural networks and the features extracted from the observations, wherein each of the neural networks is trained to estimate the behavior for the aircraft system for a different time step in the time steps.

20. The method of claim 19, wherein the aircraft system is selected from a group comprising a single aircraft and a plurality of aircraft.

21. A method for determining a behavior for a vehicle system, the method comprising:
receiving, by a computer system, observations for the vehicle system, wherein the observations are for a current time;
extracting, by the computer system, features from the observations; and
estimating, by the computer system, the behavior for the vehicle system for time steps in response using neural network layer systems and the features extracted from the observations, wherein each of the neural network layer systems is trained to estimate the behavior for the vehicle system for a different time step in the time steps.

22. The method of claim 21 further comprising:
controlling operation of the vehicle system using the behavior for the vehicle system.

23. The method of claim 21, wherein the neural network layer systems are neural networks.

24. The method of claim 22, wherein the neural network layer systems are sets of layers in a neural network, wherein each set of layers has an input to receive the features extracted from the observations to output the behavior for the different time step.

25. The method of claim 22, wherein the vehicle system is selected from a group comprising a single vehicle and a plurality of vehicles.

26. A computer program product for estimating behavior, the computer program product comprising a computer readable storage medium having program instructions embodied therewith, the program instructions executable by a computer system to cause the computer system to:
receive observations for a vehicle system, wherein the observations are for a current time;
extract features from the observations; and
estimate the behavior for the vehicle system for time steps in response using neural network layer systems and the features extracted from the observations, wherein each of the neural network layer systems is trained to estimate the behavior for the vehicle system for a different time step in the time steps.
